(19) United States
(12) Patent Application Publication
(10) Pub. No.: US 2016/0283697 A1
(43) Pub. Date: Sep. 29, 2016

(54) Systems and methods of a mobile application and web-interface for tracking complete chain-of-custody of laboratory assets

(71) Applicant: Salvatore Charles Campo, South Amboy, NJ (US)

(72) Inventor: Salvatore Charles Campo, South Amboy, NJ (US)

(21) Appl. No.: 14/667,593

(22) Filed: Mar. 24, 2015

(51) Int. Cl. G06F 19/00; H04W 8/24

(52) U.S. Cl. CPC G06F 19/363; H04W 8/24

(57) ABSTRACT

A mobile application (mobile app) runs on a mobile device to virtually establish, coordinate, and maintain chain of custody of laboratory sample specimens so as to facilitate inventory management, custodianship, notifications, query, resulting, and other duties of sample management. This is also known as virtual accessioning. Users navigate through various user interface screens to log information, manage inventory, plan/track shipments, create notifications, and other functions of sample management. The mobile application can be customized to integrate with other systems such as clinical trial management systems, sample storage databases, and laboratory information management systems. The web-interface acts as the dashboard and data aggregator for end-users. The mobile application acts solely as a tool for assisting the sample and/or result management process.

### RELATED APPLICATION

This application claims benefit of provisional patent application No. 61/970,347 filed 25 Mar. 2014.

### FIELD

Clinical trials are sophisticated experiments within clinical research that determines the safety and effectiveness of medications, devices, diagnostic products and treatment regimens intended for human use. During the trial, also known as a ‘Study’, investigators recruit patients with the predetermined characteristics, administer the treatment(s) and collect data on the patients' health for a defined time period. Data include measurements such as vital signs, concentration of the study drug in the blood and/or tissues, changes to symptoms (adverse events), and health outcomes. The researchers send the data to the trial sponsor, who then analyzes the pooled data using statistical tests. Transportation, storage, and handling of billions of research specimens require the a safety and integrity as required by FDA, Good Laboratory Practices (GLP), College of American Pathologists (CAP), National Institute of Health (NIH), and other applicable regulatory bodies for sound chain-of-custody. ‘Sample’, ‘Specimen’, and ‘Asset’ all refer to the barcoded item. A ‘Site’ role consists of the local location where a specimen or asset is collected and stored. A ‘Sponsor’ role is the end-user ensuring all assets are controlled within regulatory parameters, including time of storage and temperature. They ultimately are looking for the final test data of all samples collected from their global sites. Testing may be performed at a single location for all assets. A ‘CRO’ role is the middle-contact between ‘Site’ and ‘Sponsor’ performing day-to-day monitoring of inventory and logistics.

### BACKGROUND

Sample Management, also known as accessioning, refers to the chain-of-custody for tracking laboratory specimens. It is the process of documenting the handling, management, shipping, inventory and storage of a specimen from the moment of creation (blood drawn, urine submitted, etc) to the location of its final destination or disposal. It also includes the tracking of final test results. A sample can include human, animal, reagent, antibody, device, drug, or any other medical related specimen. Assets can include medical devices or laboratory equipment. The FDA requires this information to be clear, complete, and concise for a result to be reported out quickly and accurately per Code of Federal Regulations—Title 21 (http://www.fda.gov/medicaldevices/deviceregulationandguidance/databases/ucm135680.htm).

### BRIEF DESCRIPTION OF DRAWINGS

FIG. 1: Permission hierarchy of roles assigned to a user from authorized Super Admin. Depending on role, user will have certain pre-assigned features activated.

FIG. 2: High-level detail of process work flow

FIG. 3: Mobile App login protection

FIGS. 4a-f: Mobile App add patient to study and see visit information

FIGS. 5a-b: Mobile App visit detail and scanning function

FIGS. 6a-b: Mobile App capture and edit document image

FIGS. 7a-c: Mobile App outgoing manifest

FIGS. 8a-b: Mobile App incoming Manifest

FIG. 9: Mobile App notifications of samples ready to ship (expiring), incoming and outgoing manifests, and other pertinent site-level info

FIGS. 10a-d: Mobile App study list and details

FIG. 11: Web-interface login

FIG. 12: Web-interface Super Admin user: list of Sponsor/CRO users

FIG. 13: Web-interface Super Admin user: add a Sponsor/CRO user

FIG. 14: Web-interface Super Admin user: list of sites

FIG. 15: Web-interface Super Admin user: add a site

FIG. 16: CRO/Sponsor user: Super Admin user: domain-controlled users

FIG. 17: Web-interface CRO/Sponsor user: dashboard

FIG. 18: Web-interface CRO/Sponsor user: add a site and coordinator

FIG. 19: Web-interface CRO/Sponsor user: list of studies

FIG. 20: Web-interface CRO/Sponsor user: add study and expected visits

FIG. 21: Web-interface CRO/Sponsor user: edit existing study

FIG. 22: Web-interface CRO/Sponsor user: manifest dashboard

FIG. 23: Web-interface Site user: add personnel

FIG. 24: Web-interface Site user: list of studies

FIG. 25: Web-interface Site user: study status and details

FIG. 26: Web-interface Site user: list of manifests

FIG. 27: Web-interface Site user: manifest detail

### DETAILED DESCRIPTION

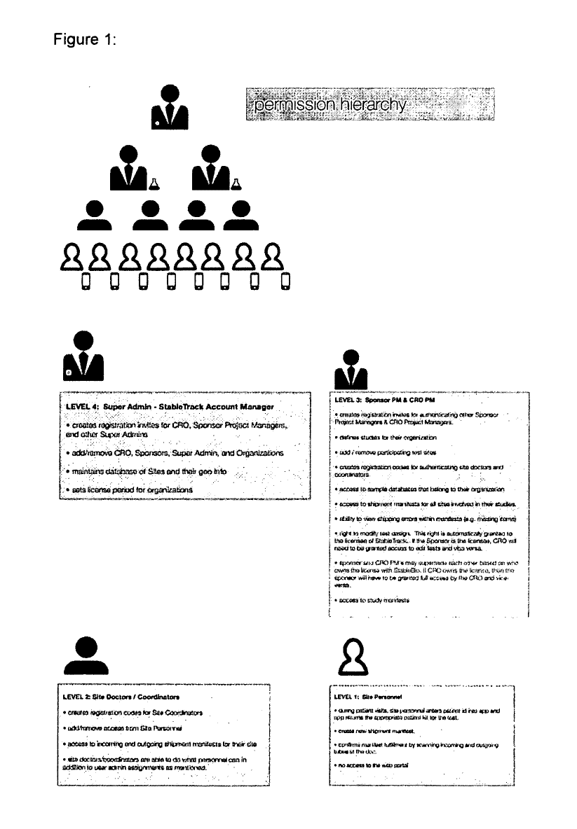

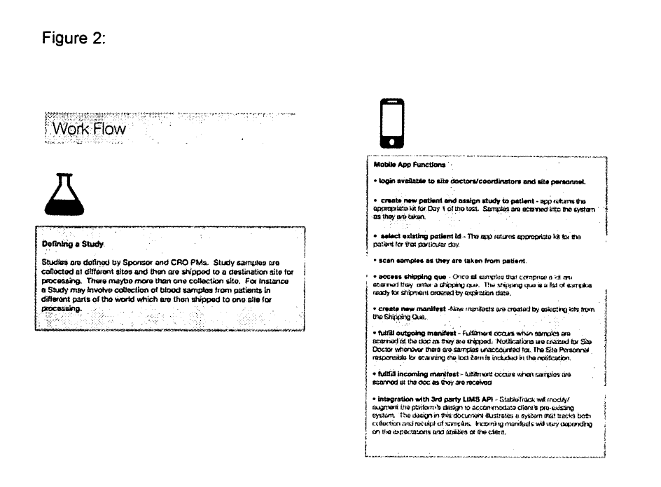

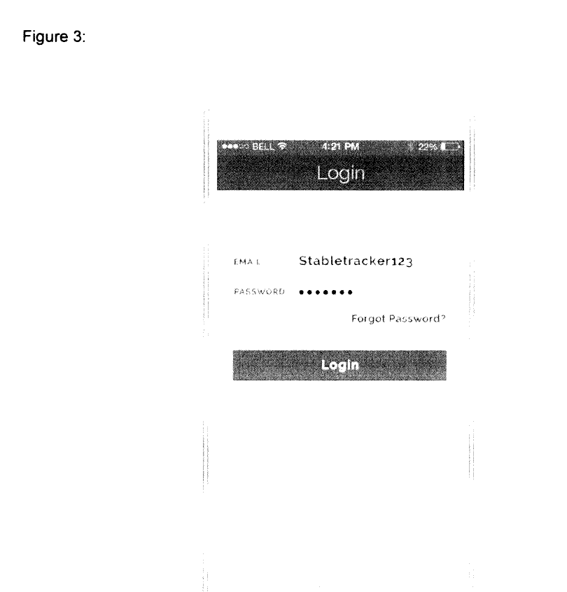

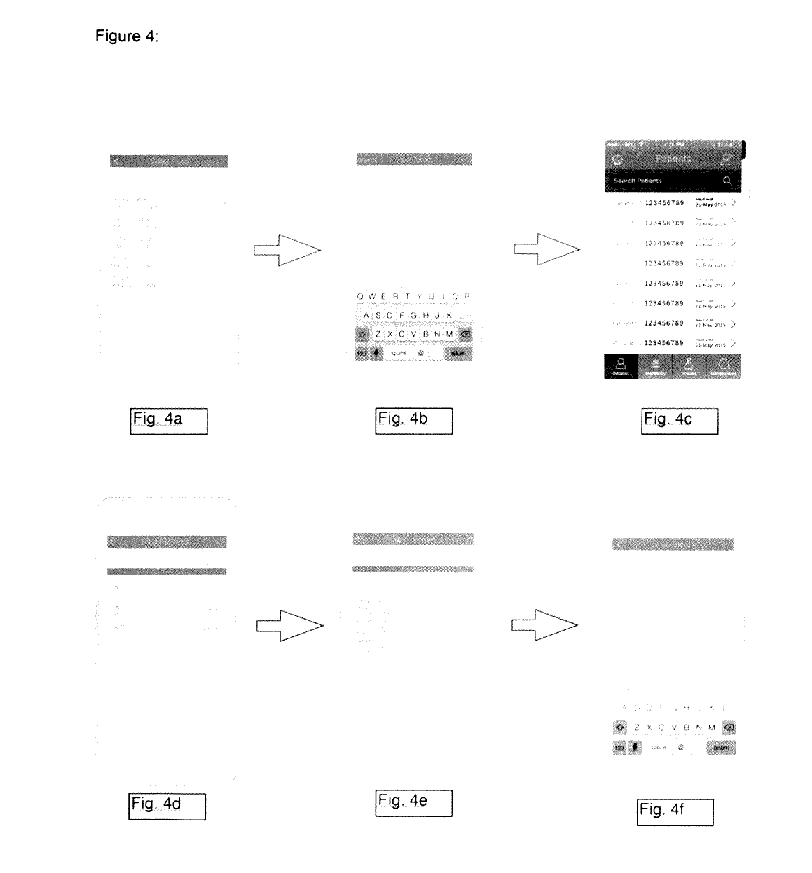

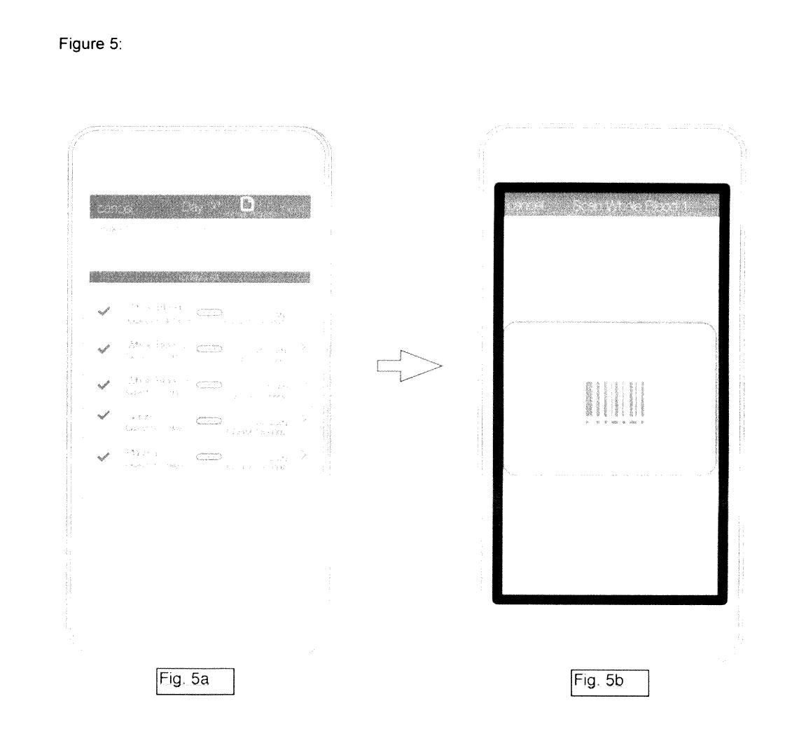

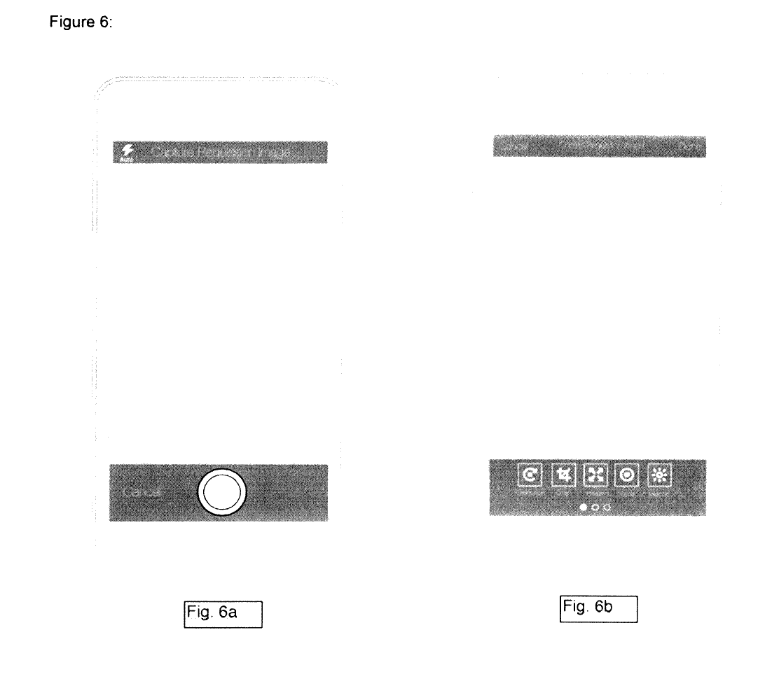

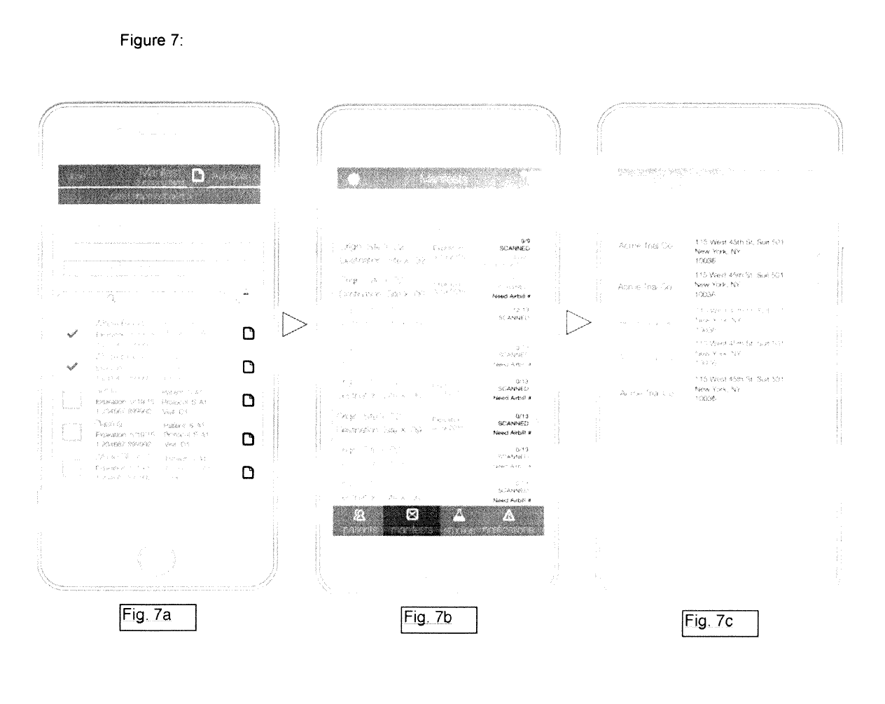

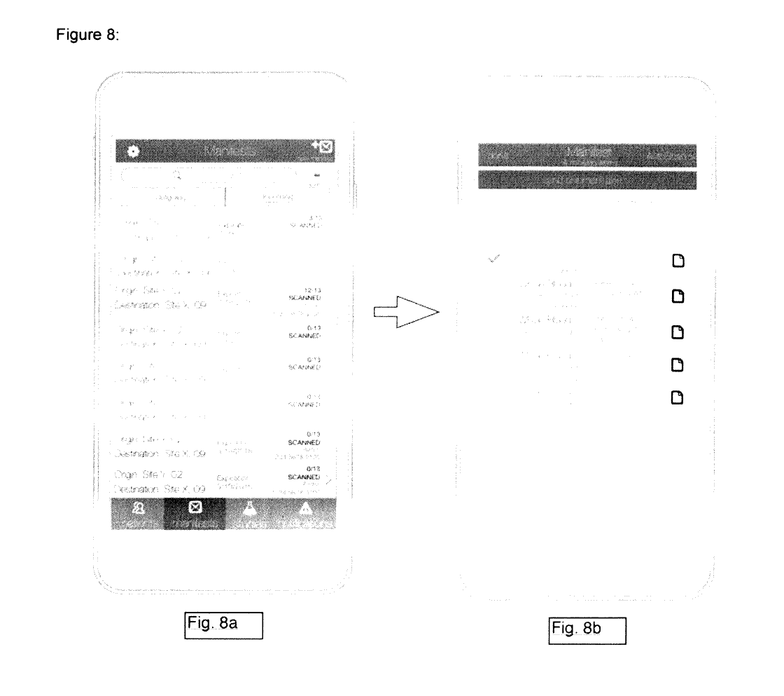

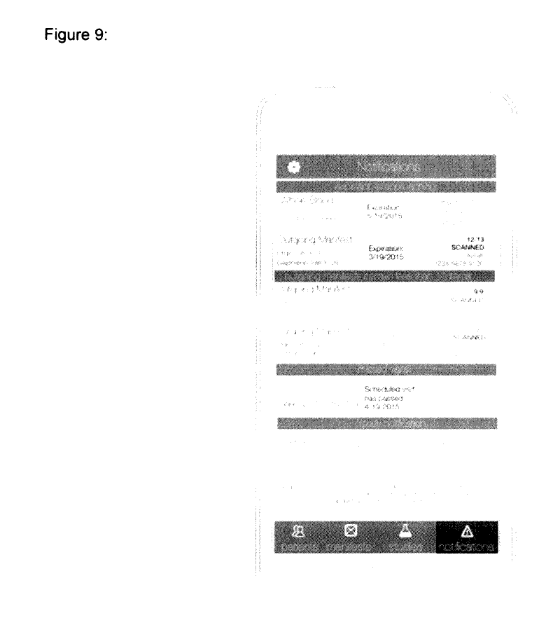

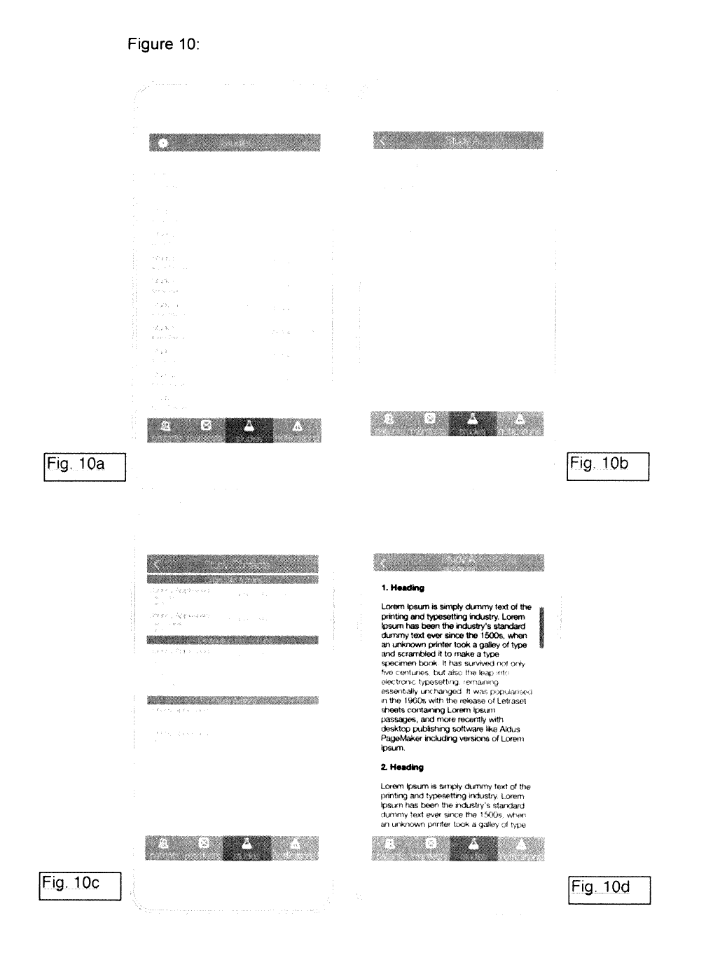

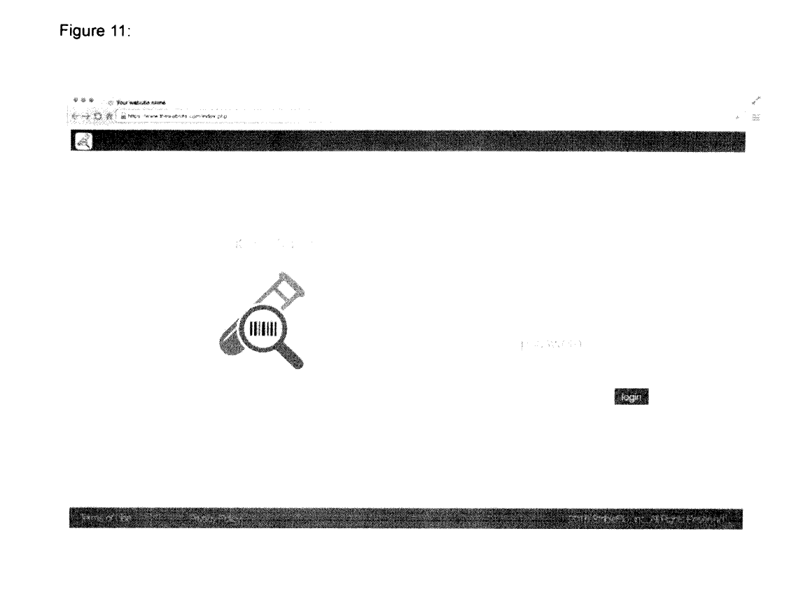

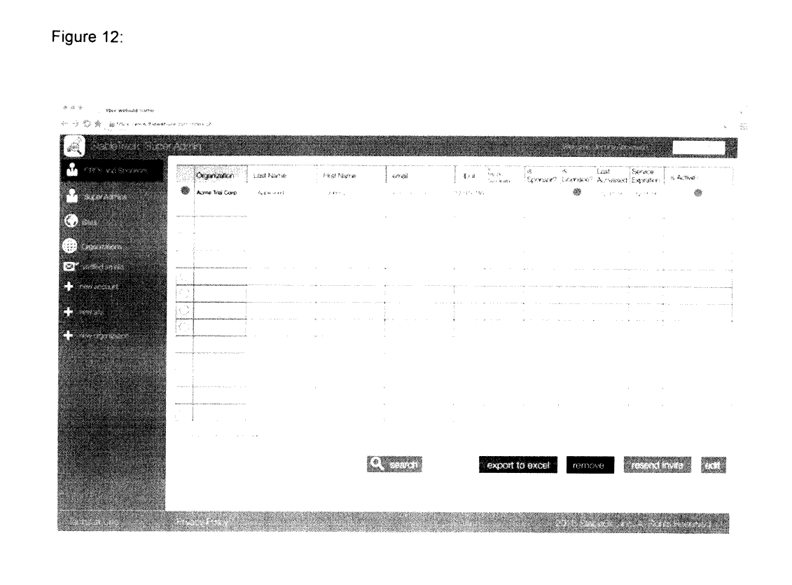

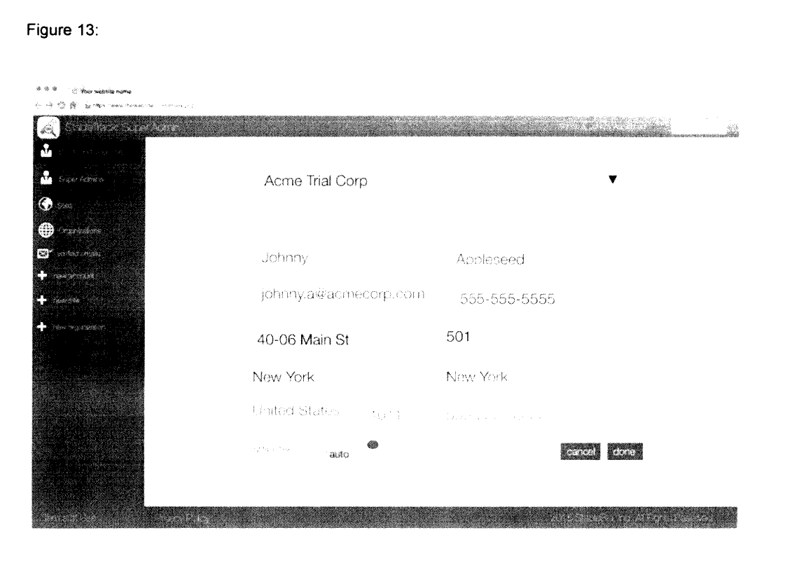

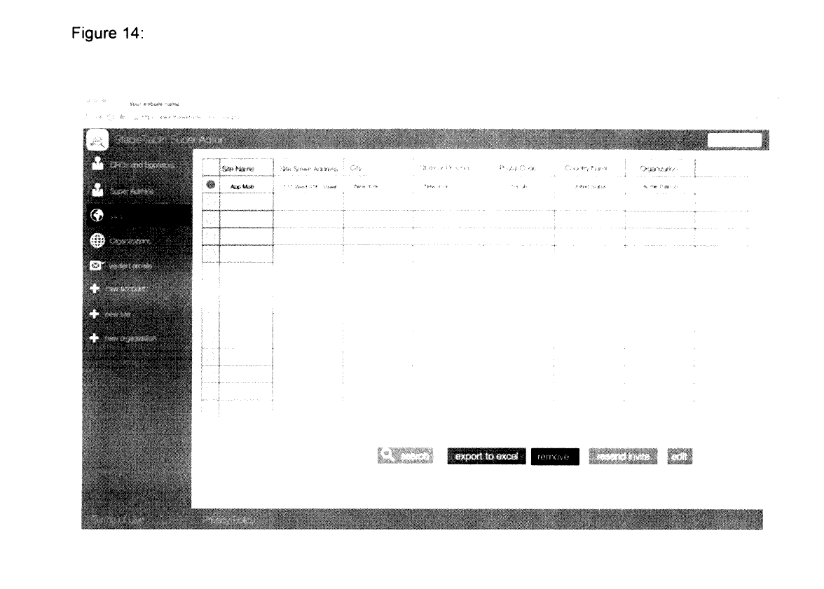

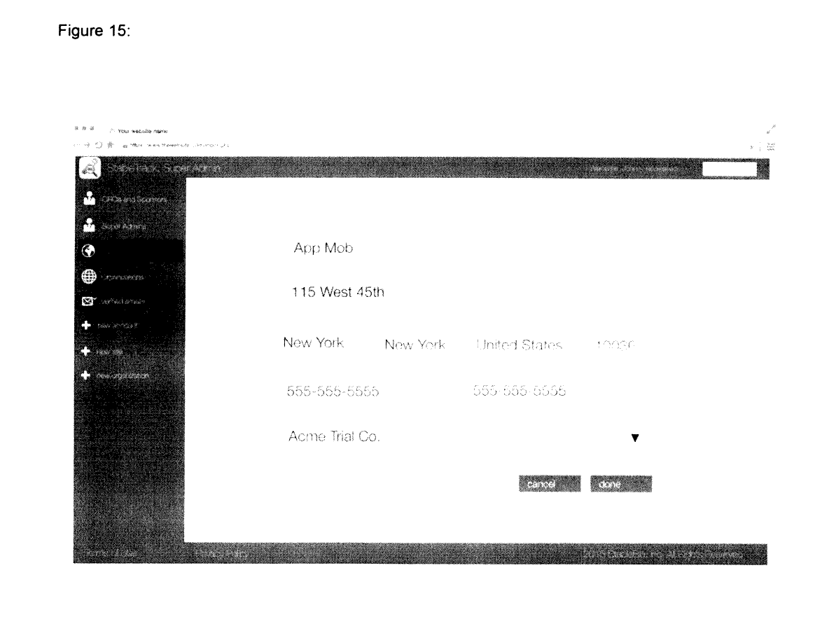

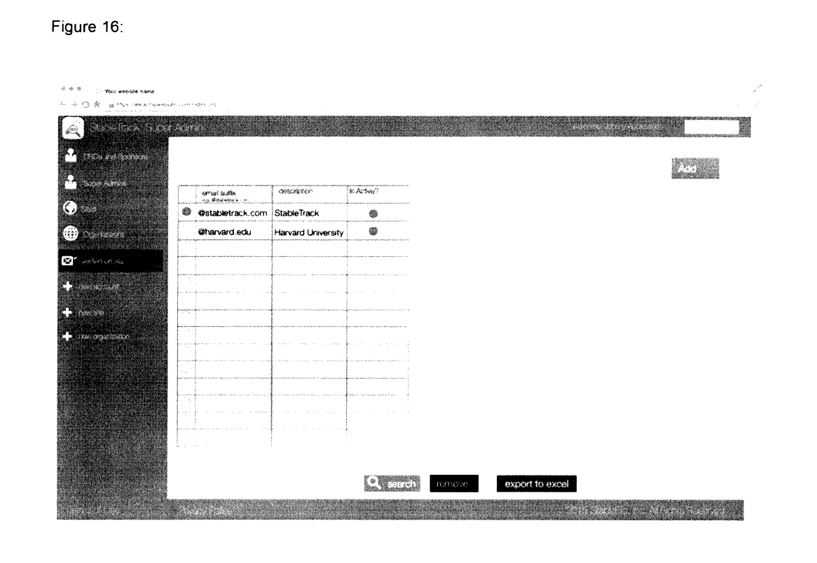

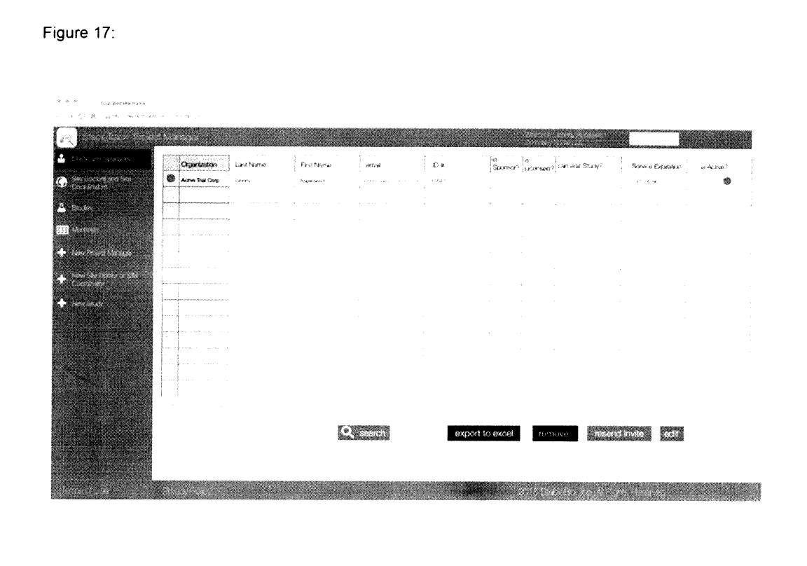

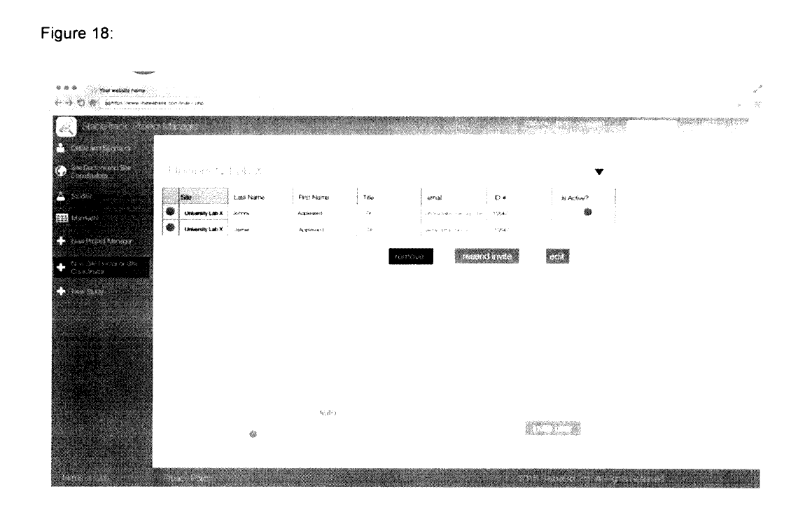

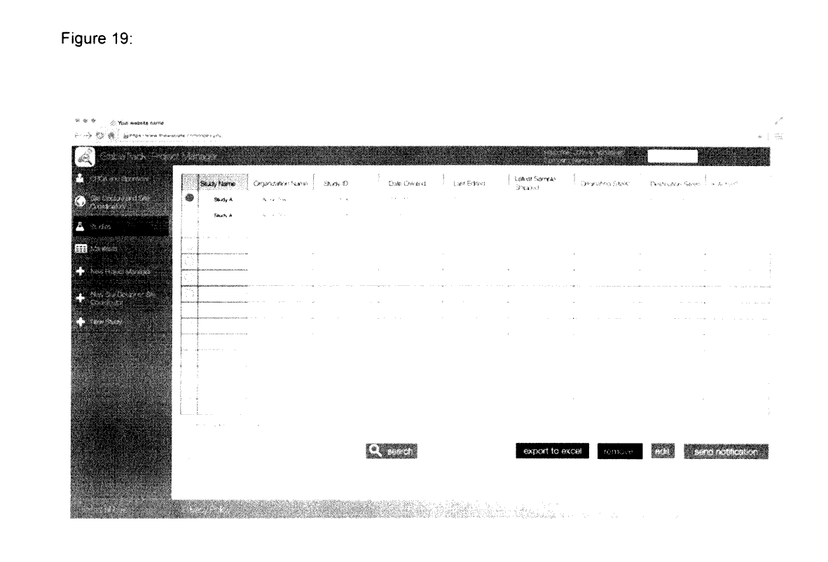

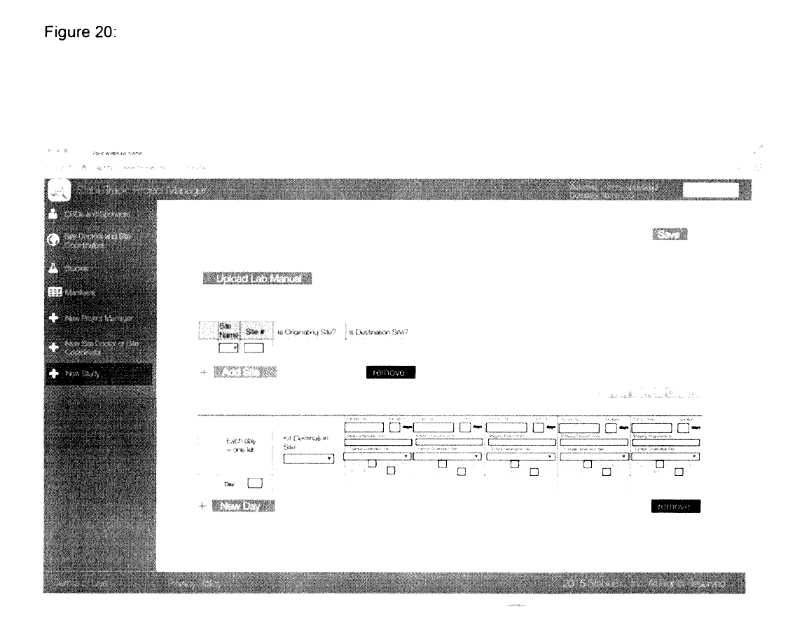

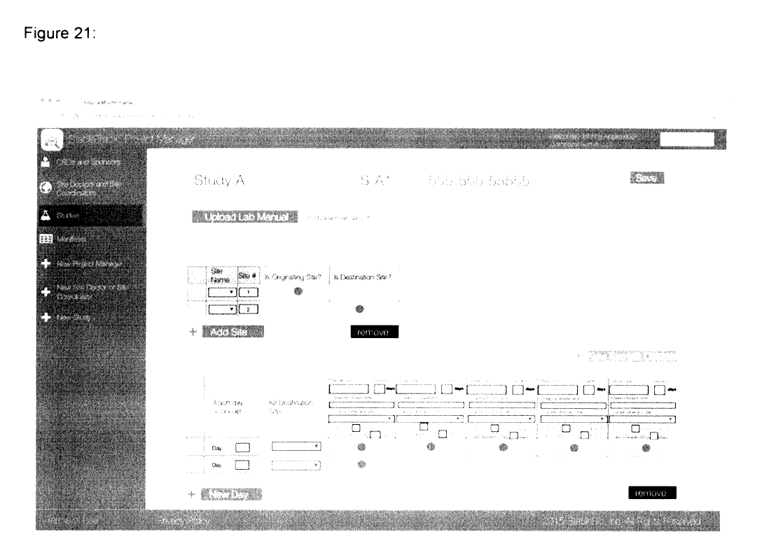

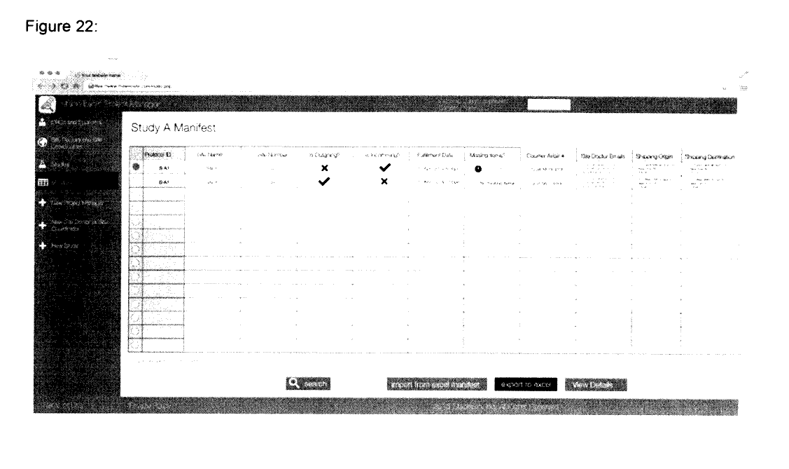

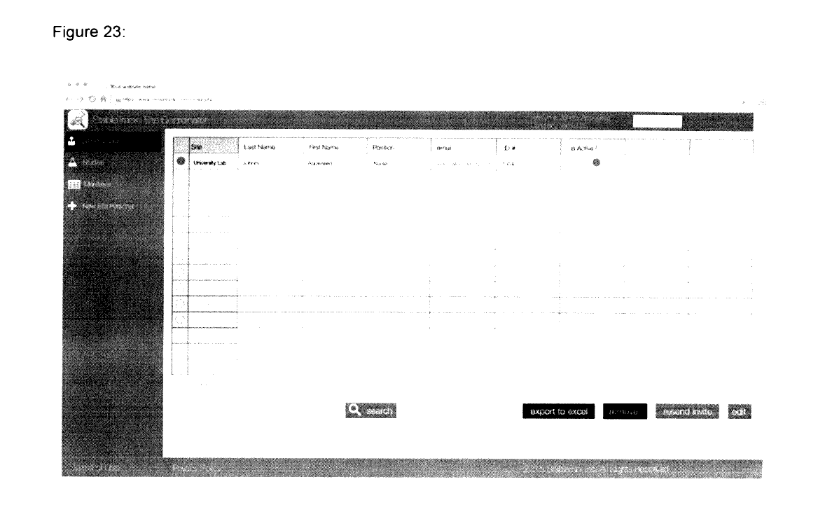

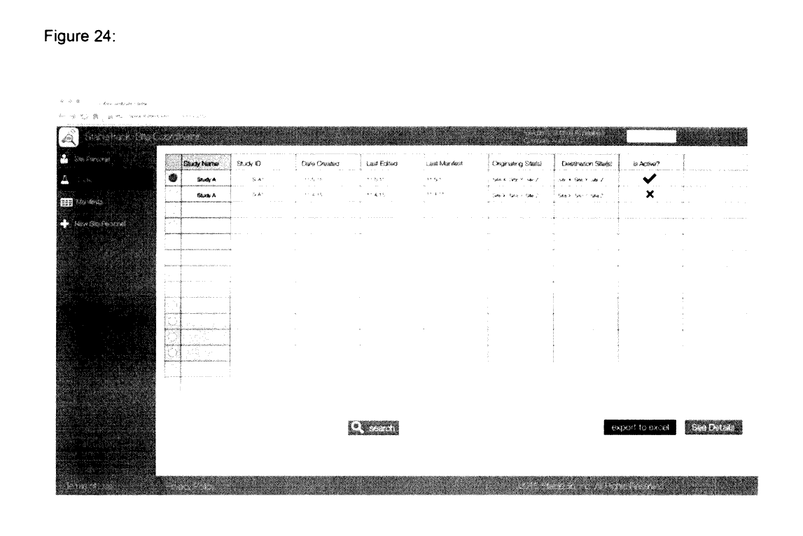

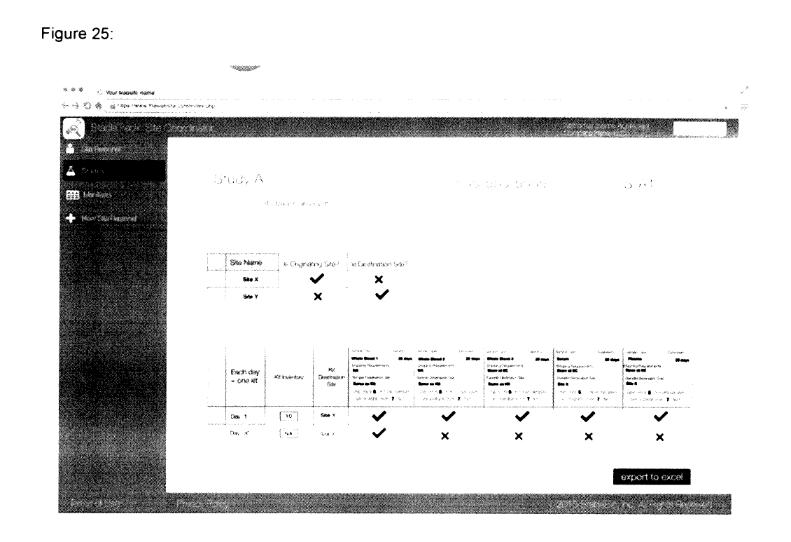

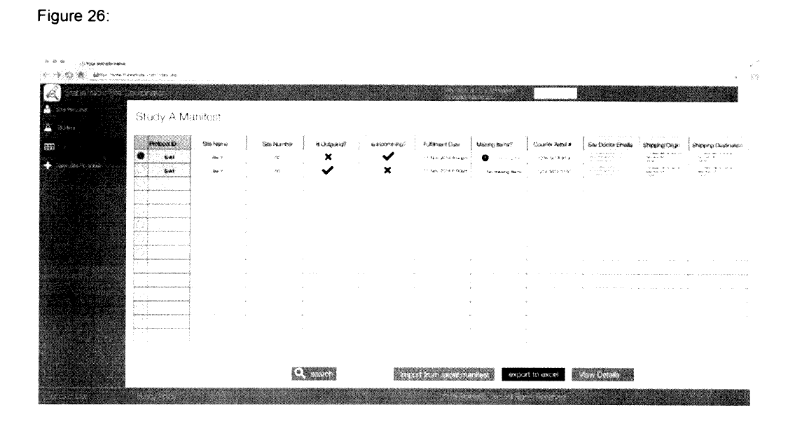

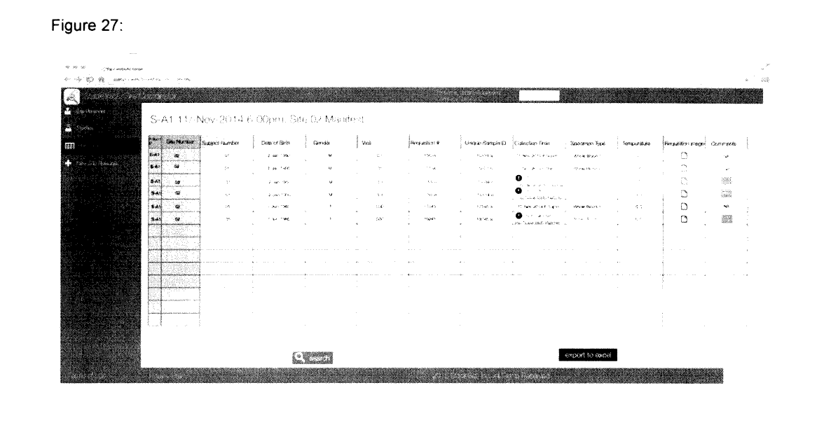

The use of mobile devices has expanded into healthcare for routine industry functions that include communication, patient monitoring, prescription orders, and logistics. This patent is for the systems and interface of a realtime global inventory tracking application of barcoded research specimens and assets using mobile, secure network, and web platforms. The permission hierarchy of roles as defined by FIG. 1 is assigned by the Super Admin role that can create the subsequent roles. As Super Admin and similarly as Sponsor/CRO project manager roles, a single clinical research study has its requirements and expectations defined using the web-interface. Information including stability of a blood specimen and when batches of specimens should be shipped are created and then synchronized with globally authorized mobile devices of Site coordinators and doctors remotely located across the study. FIG. 2 is the work flow detail of the system briefly defining the study setup and mobile application process. FIG. 3 is the mobile app login screen that is authorized by a Super Admin. As seen in FIG. 4, a patient can be added to a study through the mobile app. List of authorized studies are identified within the mobile app (FIG. 4a). User can enter new patient info as defined by study (FIG. 4b) or select a patient already in the study (FIG. 4c). As a patient is selected, the user will begin by selecting the necessary visit as defined by the study parameters (FIG. 4d) and collect specimen from patient with tubes or other items that include barcoded labels. The pre-designed samples are listed in FIG. 4e and the user can add any comments as show in FIG. 4f. These barcoded assets (FIG. 5a) are then scanned (FIG. 5b) by mobile app to monitor inventory. Any associated paperwork for that patient's visit is then photographed (FIG. 6a) and verified by user (FIG. 6b) using the mobile app. These create a complete patient set of demographics, specimens, and documents captured in a single digital location. This set can be exported to spreadsheet software applications such as excel or other secured means for central monitoring. FIG. 7 shows how specimens can then be shipped to another location in batches. As user selects either patient sets of specimens or the same specimen type across patients (ie all blood or urine) (FIG. 7a), it will create a shipment manifest of items that user scans to confirm they are all in the shipment (FIG. 7b). This manifest can be shared with receiving location and other authorized users, including project manager at Sponsor/CRO. The demographics and photographed documents are also included in the manifest file (FIG. 7c). User will also be able to scan the shipping courier airbill barcode for tracking with integration services. The mobile app will warn user if there are unnecessary items or if this shipment does not meet the minimum defined number (ie ship 100 specimens at a time). Mobile app will also warn of inclement weather or weekend delivery concerns based on geolocation and internal calendar of device. FIG. 8a shows when specimens arrive at receiving lab, user on receiving end will scan barcodes to confirm receipt and immediately document any discrepancies or issues for realtime communication between sending location, receiving location, and Sponsor/CRO project managers (FIG. 8b). Notifications of upcoming shipment deadlines, specimens nearing end-of-stability, and other alerts are sent to the user, as shown in FIG. 9. FIG. 10a and FIG. 10b show study-specific information is defined within the web-interface and able to be synchronized across all remote sites (both on web and mobile). This information can include contact info (FIG. 10c), lab manual of collection instructions (FIG. 10d), schedule of visits for patients, and other expectations of study management. This information can be uploaded in .pdf and video form. FIG. 11 is the web-interface login screen. As previously detailed in the permission hierarchy, FIG. 12 is the landing page where a Super Admin can setup roles for the application. From here, the user can view other users by organization and relevant account information. All spreadsheet-style pages can be exported. FIG. 13 displays all of the assigned user information entered by a Super Admin. FIG. 14 are the list of sites from a master-level. Since the same site may participate in multiple studies, this allows the system to arrange shipment of multiple clinical trial specimens going to the same location. FIG. 15 displays all of the site information entered by a Super Admin. To ensure secure users, only authorized email domains are permitted, these are assigned as shown in FIG. 16. FIG. 17 begins the landing page for CRO/Sponsor project managers. Users at this level will only see studies assigned to them by Super Admins and have editing capability as applicable. FIG. 18 shows how a Site is added to a study, which is then added to the study list as shown in FIG. 19. Once a study is added, project manager will add study information including visits, specimens expected, and other information such as lab manual and specimen shipment expectations as shown in FIG. 20. FIG. 21 shows a completed study entry. As specimens are entered using the mobile app, permitted users can view the progress of collections, manage shipment requests, and resolve any discrepancies (FIG. 22). Site-level users will also have access to the web-interface as seen in FIG. 23. They'll be able to view only their own site's info, but on a computer instead of mobile if desired. Advanced features such as seeing information across all studies they are participating are available (FIG. 24 and FIG. 25). FIG. 26 is the site-level manifests page, where all previous and upcoming shipments are listed, including any information that might be missing. This allows the site to ensure all requested specimens are shipped out. FIG. 27 is an example of one manifest with specimens missing, where they can be resolved, syncing with CRO/Sponsor project managers.

1. Mobile data capture function of this patent is a process to capture clinical research specimen and document information in a single digital location using mobile technology capable of exporting without the need for a traditional computer.

2. Clinical research specimen and document information that is captured in a single digital location using mobile technology across multiple locations is synced from point of shipment to receipt as users scan barcodes and immediately document any discrepancies or issues for realtime communication between sending location, receiving location, and authorized users.

3. Mobile application alerts user if there are unnecessary items in a shipment, if a shipment does not meet the minimum defined number of items (ie ship 100 specimens at a time), inclement weather or weekend delivery concerns based on geolocation and internal calendar of device.

4. Mobile application is an inventory tracker of assets internally collected and stored at site with ability of authorized users to see global inventory across sites.

5. Web-interface and mobile app synchronization enables realtime study updates and requirements to be sent across global remote devices from a Super Admin level.
